(19) United States
(12) Patent Application Publication
(10) Pub. No.: US 2022/0300033 A1
(43) Pub. Date: Sep. 22, 2022

(54) COMPUTER CASE WITH INTEGRATED TILT STAND

(71) Applicants: Mark Zadvinskis, Saline, MI (US); Adam Ostroff, West Bloomfield, MI (US)

(72) Inventors: Mark Zadvinskis, Saline, MI (US); Adam Ostroff, West Bloomfield, MI (US)

(21) Appl. No.: 17/698,403

(22) Filed: Mar. 18, 2022

Related U.S. Application Data
(60) Provisional application No. 63/163,147, filed on Mar. 19, 2021.

(51) Int. Cl. G06F 1/16

(52) U.S. Cl. CPC G06F 1/166

(57) ABSTRACT

A protective sleeve/computer case converts into an adjustable podium-like stand, raising the height of the screen to a more ergonomic level. The top and bottom panels of the case are hinged, with a fold-out support member having a first portion hinged to the inner surface of the top panel. A structure on the inner surface of the bottom panel is configured to receive the second portion of the support member, such that when the second portion of the support member is received by the structure, the top and bottom panels form an angle. With the outer surface of the bottom panel positioned on a support surface, the outer surface of the top panel is adapted to receive the computer for use at the angle relative to the support surface. The structure configured to adjustably receive the support member may be molded into the bottom cover of the case.

### REFERENCE TO RELATED APPLICATIONS

This application claims priority to and the benefit of U.S. Provisional Patent Application Ser. No. 63/163,147, filed Mar. 19, 2021, the entire content of which is incorporated herein by reference.

### FIELD OF THE INVENTION

This invention relates generally to cases for laptops and other mobile computing devices and, in particular, to a case having an integral tilt stand.

### SUMMARY OF THE INVENTION

This invention is directed to a protective sleeve and carrying case for a laptop or tablet which converts into an adjustable lapdesk or podium-like stand. This raises the height of the computer screen closer to the eye level of the user for a more natural viewing angle when working mobile such as in airports or on a desktop. The invention decreases the amount of neck bending when looking down to a laptop screen, thereby providing a better angle for multiple work situations, including webcam viewing.

A computer case according to the invention comprises opposing top and bottom panels with inner and outer surfaces forming an enclosure with front, rear and opposing side edges. The edges of the top and bottom panels may be curved or angled toward one another such that the panels form a clamshell-type case, with one or more zippers along the side and rear edges of the case. A carrying handle may extend from the rear edge(s).

The front edges of the panels are hinged, enabling a user to open and close the case so as to gain access to an interior of the case, which is configured to receive the computer. The case includes a fold-out support member having a first portion hinged to the inner surface of the top panel. A structure on the inner surface of the bottom panel is configured to receive the second portion of the support member, such that when the second portion of the support member is received by the structure, the top and bottom panels are in a partially open condition forming an angle with respect to one another. As such, with the outer surface of the bottom panel positioned on a support surface, the outer surface of the top panel is adapted to receive the computer for use at the angle relative to the support surface.

In the preferred embodiment, the structure on the inner surface of the bottom panel includes different regions to receive the second portion of the support member so as to establish different angles between the top and bottom panels. The angle between the top and bottom panels may be adjustable between 15 to 45 degrees or, more preferably, between 25 to 35 degrees. The outer surface of the top panel may include a non-skid surface, and the case may further include a computer-retaining lip proximate to the front edge of the outer surface of the top panel.

The support member preferably folds out toward the rear portion of the case, and support member is preferably a rigid or semi-rigid panel. The second portion of the support member may include a plurality of feet, with the structure on the inner surface of the bottom panel being configured to receive the feet. In the preferred embodiment, the bottom panel is formed such that the structure on the inner surface of the bottom panel is reproduced on the outer surface of the bottom panel. Thus, the bottom panel may be molded to form the structure on the inner surface thereof.

### BRIEF DESCRIPTION OF THE DRAWINGS

FIG. 1A is a perspective view of a computer case according to the invention in a closed condition;

FIG. 1B is a top-down view of the computer case of FIG. 1A;

FIG. 1C is a front view of the computer case of FIG. 1A;

FIG. 1D is a side view of the computer case of FIG. 1A;

FIG. 1E is a bottom view of the computer case of FIG. 1A;

FIG. 2A is a perspective view of the computer case of FIG. 1A in a partially open condition;

FIG. 2B is a perspective view of the computer case with the computer removed and an integral tilt stand in a selected position;

FIG. 2C is a perspective view of the computer case with the computer placed on the case in a tilted condition;

FIG. 3A is a side view illustrating how the integral foot is adjusted to achieve a tilt angle of about 35 degrees;

FIG. 3B is a side view illustrating the tilt stand at an angle of about 30 degrees;

FIG. 3C is a side view illustrating the tilt stand at an angle of about 25 degrees;

FIG. 4A is a perspective and front view showing a fold-up retainer lip in a stowed position;

FIG. 4B is a perspective view showing the fold-up retainer lip in an open position;

FIG. 4C shows a computer on the tilt case being retained by the fold-up lip;

FIG. 5A is a front view showing a laptop or notebook computer on the case in a tilted configuration;

FIG. 5B is a rear view showing a laptop or notebook computer on the case in a tilted configuration, and wherein the support member is a solid panel;

FIG. 5C is a side view showing a laptop or notebook computer on the case in a tilted configuration;

FIG. 5D is a rear perspective view showing a laptop or notebook computer on the case in a tilted configuration; and

FIG. 5E is a front perspective view showing a laptop or notebook computer on the case in a tilted configuration, and with a flip-up retaining lip assisting with maintaining the computer in a stable condition for use.

### DETAILED DESCRIPTION OF THE PREFERRED EMBODIMENTS

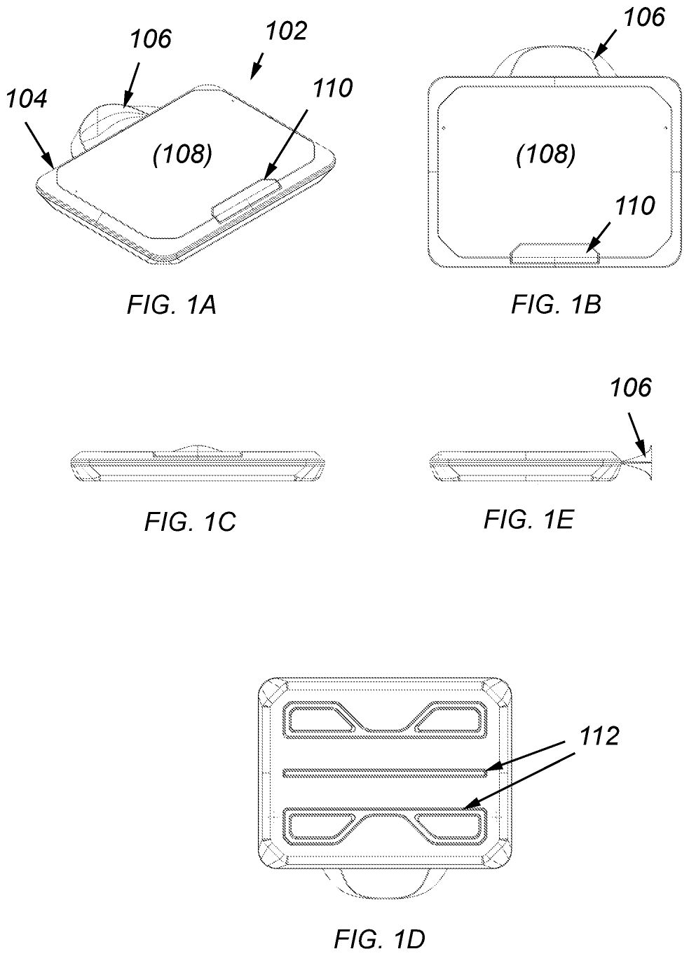

Now making reference to the accompanying drawing, FIG. 1A a perspective view of a computer case 102 according to the invention in a closed condition. FIG. 1B is a top view, FIG. 1C is a front view, FIG. 1D is a bottom view, and FIG. 1E is a side view. The case further includes a rear portion 104 with carrying handles 106. The top portion of the case 102 preferably includes a flat surface 108, and the front portion of the case includes a flip-up lip 110 described in further detail herein.

The case may be constructed of any durable, formable materials, including molded plastics, stamped metal, etc. In preferred embodiments, the case is constructed from ethylene-vinyl acetate (EVA) molded foam, and preferably includes relief patterns to provide decoration and/or strength. For example, the top and/or bottom of the case may include raised structures such as 112. Computer support surface 108 may be realized with a rigid or semi-rigid panel, either integrally molded or affixed to the top surface of the case. The inner and/or outer surfaces of the case itself may be smooth or textured. The front edges of the top and bottom portions of the case are hinged with a flexible material, with one or two zippers being used for a peripheral closure.

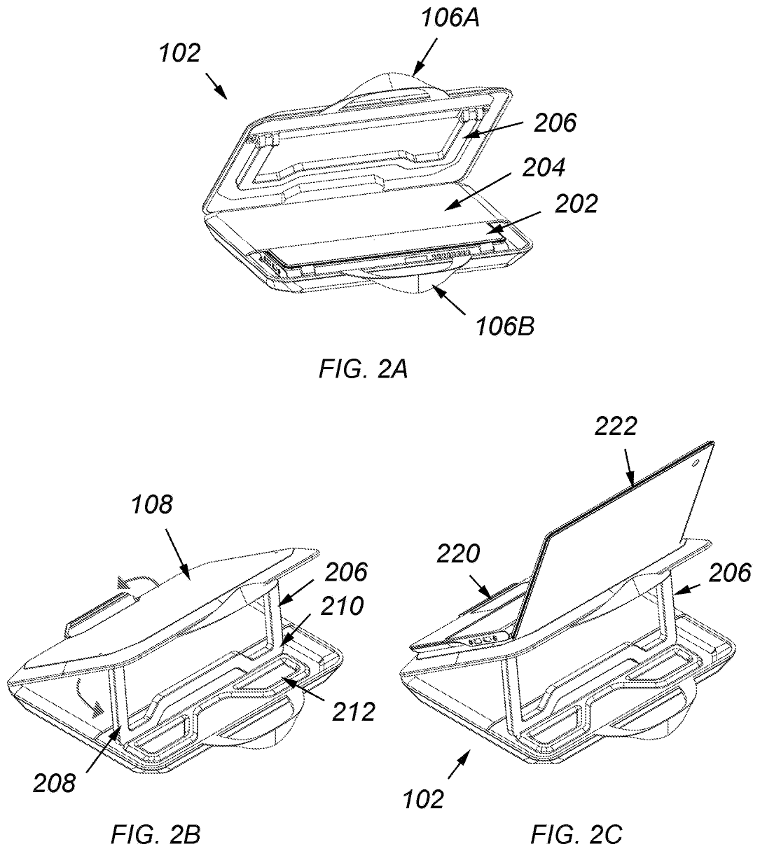

FIG. 2A is a rear perspective view showing the case in an open condition. Note that two handles may be provided, 106A, 106B, extending from respective rear edges of the top and bottom portions of the case 102, respectively. The view of FIG. 2A also shows a laptop computer 202 contained in a compartment formed by partition 204. In the preferred embodiments, the partition 204 is at least flexible, if not stretchable, enabling the computer to be easily removed for use.

It should be understood that the invention is not limited in terms of the computer accommodated by the case, which may come from any manufacturer and in any size (i.e., 12″, 14″, 16″ and so forth). Further, while the invention is intended for laptop or notebook computers of the type which include a hinged, clamshell configuration, the case may also be used with pad-type units or any mobile computing device.

Removal of the computer better reveals internal structures facilitating tilt functionality. In particular, the inside of the top of the case includes a fold-out pivoting leg structure 206 with opposing side “feet” 208, 210. FIG. 2A shows one way in which the leg structure may be hingedly coupled to the inner surface of the case. The inner surface of the bottom of the case includes foot-retaining structure 212 with that receives the feet in different regions to provide for an adjustable tilt as described in further detail below. Note that the laptop 202 is disposed against the foot-retaining structure 212 until the computer is removed for use.

The fold-out leg structure 206 and hinges are preferably molded plastic parts, though other lightweight rigid or semi-rigid materials may be used such as metal, wood, carbon fiber, etc. In the preferred embodiments, the foot-retaining structure does not required additional parts; rather, the molding of the bottom of the case serves the multiple purposes of decoration, strength, anti-slip, and foot-receiving regions.

While the drawings show a preferred fold-out leg structure 206 and foot-retaining features 212, the invention is by no means limited to these particular designs. The fold-out leg structure 206 may have more or fewer feet, and foot-retaining structure 212 may assume a different physical configuration. Thus, while the fold-out leg structure is depicted as being an open member with two “feet,” the structure may be a solid panel with a generally straight bottom edge retained by elongated ridges the bottom panel, or the bottom portion of the fold-out structure may have more than two “feet” retained by multiple recesses in the bottom panel.

Indeed, it may be possible to reverse the positions of the fold-out and retaining structures. Overall, the invention anticipates and structure internal to the case that enables the top and bottom of the case to be maintained at an angle as described herein, more preferably at an adjustable angle. Thus, a purely frictional leg positioning, hook-and-loop surfaces, or any other arrangement or mechanism may be used that provides for temporary angular adjustment of the top and bottom portions of the case.

FIG. 2C is a rear, perspective view identical to the view shown in FIG. 2B, but now the computer 202 has been removed on the case and placed on the tilted top surface of the case 102. The computer has been opened up, such that the keyboard portion of the case is supported at the angle of the top surface 108, and the display portion of computer is adjusted for user preference.

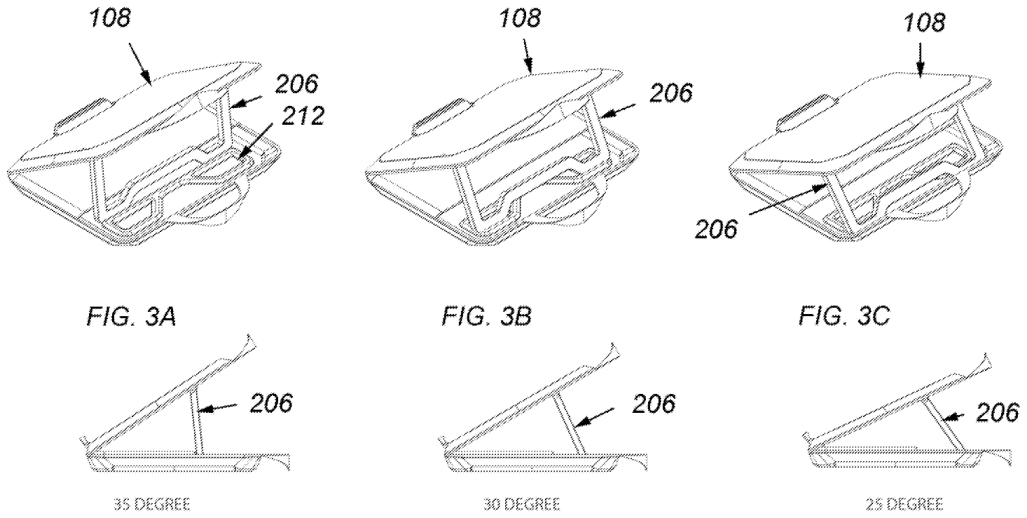

FIG. 3 is a series of drawings that show how the tilt mechanism may be adjusted to achieve a plurality of angles. In FIG. 3A, the feet of the leg structure 206 are placed in a first set of notches in the retaining structure to establish an angle of about 35 degrees. Note that in this configuration, the leg structure 206 is near vertical. In FIG. 3B, the leg 206 has been moved rearwardly into a different set of notches to achieve a 30 degree angle, and in FIG. 3C, the leg 206 has been moved again to create an angle of 25 degrees, more or less. Again, while three different angles are shown, the invention is not limited in this regard, as more of fewer angles may be established through appropriate engineering modification of the leg/foot/retainer arrangement.

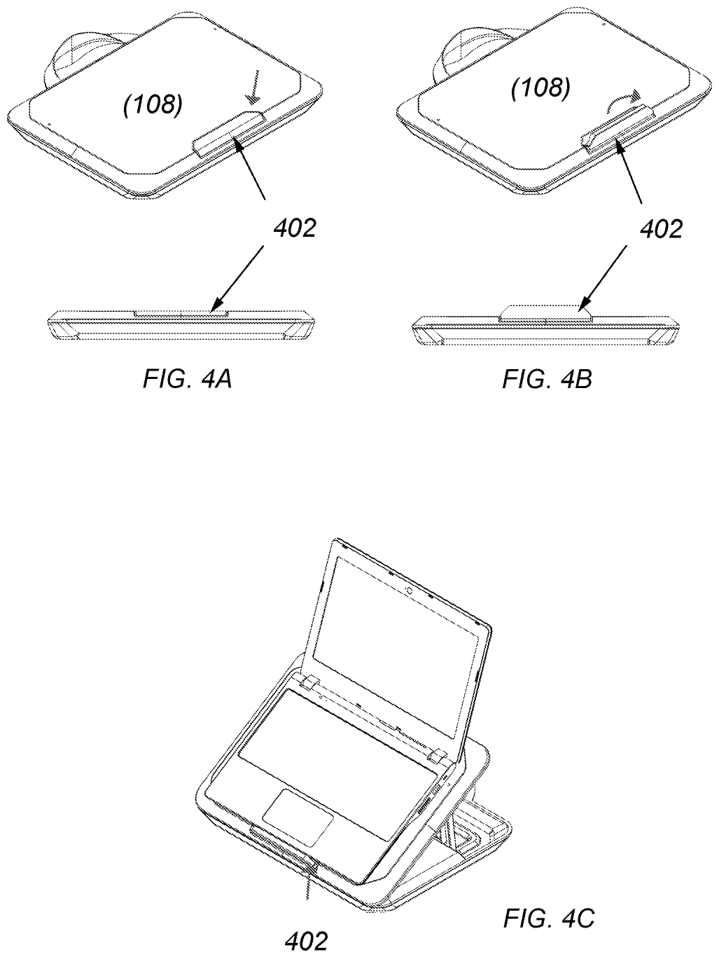

Any device, surface or mechanism may be used to keep the computer from sliding down on the top surface when the computer is in position for use on the tilted top surface of the case. The preferred embodiment incorporates a flip-up lip structure. As shown in FIG. 4A, such a lip 402 folds flat against the case when not in use. To deploy, the lip 402 is folded outwardly, as shown in FIG. 4B, and FIG. 4C shows the way in which the bottom edge of laptop 102, rests lip 502 to secure the computer in position for use.

Lip 402 is preferably a plastic part having a relatively short width positioned in the lower portion of the top of the case. However, the lip may be wider, up to the entire width of the case or, alternatively, multiple fold-up lips may be used. Regardless, whatever the retaining structure, the outer surface of the top of the case (i.e., the surface of 108), may include a non-skid surface to assist with secure positioning of the computer 102). While the lip 402 may be spring-biased outwardly, in preferred embodiments the lip is implemented with a simple hinged ledge that snaps into position when not in use.

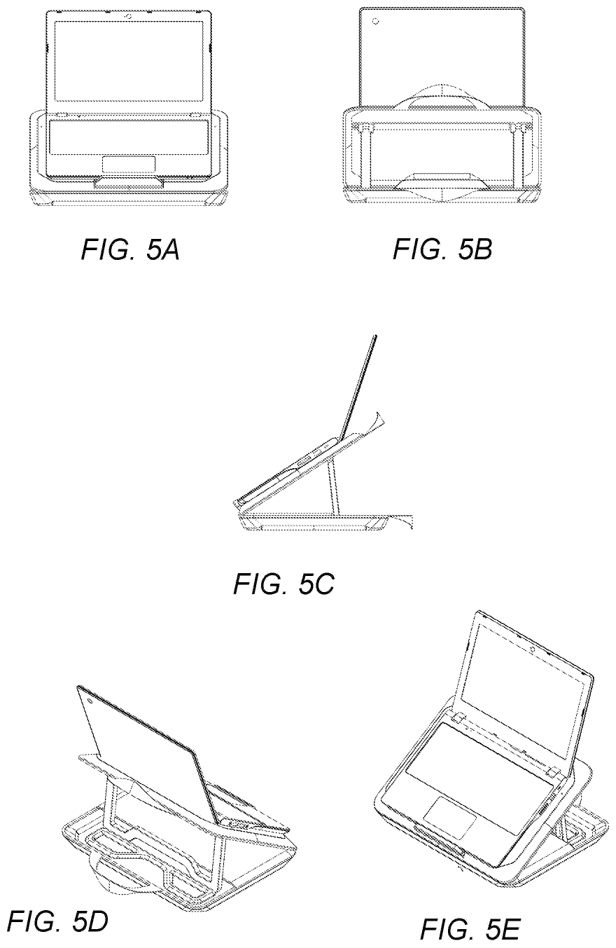

FIG. 5 presents different views of the inventive case at a 35-degree angle, with a laptop mounted thereon, including a front view (FIG. 5A); rear view (FIG. 5B); side view (FIG. 5C); rear ortho view (FIG. 5D); and front ortho view (FIG. 5E). maintaining the computer in a stable condition for use.

1. A computer case, comprising:
opposing top and bottom panels with inner and outer surfaces forming a case with front, rear and opposing side edges;
wherein the front edges of the panels are hinged, enabling a user to open and close the case so as to gain access to an interior of the case configured to receive the computer;
a fold-out support member having opposing first and second portions, and wherein the first portion of the support member is hinged to the inner surface of the top panel;
a structure on the inner surface of the bottom panel configured to receive the second portion of the support member, such that when the second portion of the support member is received by the structure, the top and bottom panels are in a partially open condition forming an angle with respect to one another; and
wherein, with the outer surface of the bottom panel positioned on a support surface, the outer surface of the top panel is adapted to receive the computer for use at the angle relative to the support surface.

2. The computer case of claim 1, wherein the structure on the inner surface of the bottom panel includes different regions to receive the second portion of the support member to establish different angles between the top and bottom panels.

3. The computer case of claim 1, wherein the angle between the top and bottom panels is adjustable between 15 to 45 degrees.

4. The computer case of claim 1, wherein the angle between the top and bottom panels is adjustable between 25 to 35 degrees.

5. The computer case of claim 1, further including a computer-retaining lip proximate to the front edge of the outer surface of the top panel.

6. The computer case of claim 1, further including a fold-out computer-retaining lip proximate to the front edge of the outer surface of the top panel.

7. The computer case of claim 1, wherein the support member folds out toward the rear portion of the case.

8. The computer case of claim 1, wherein the support member is a rigid or semi-rigid panel.

9. The computer case of claim 1, wherein:
the second portion of the support member includes a plurality of feet; and
the structure on the inner surface of the bottom panel is configured to receive the feet.

10. The computer case of claim 1, wherein the outer surface of the top panel includes a non-skid surface.

11. The computer case of claim 1, wherein the edges of the top and bottom panels are curved or angled toward one another such that the panels form a clamshell case.

12. The computer case of claim 1, including one or more zippers to close the back and side edges.

13. The computer case of claim 1, wherein the bottom panel is formed such that the structure on the inner surface of the bottom panel is reproduced on the outer surface of the bottom panel.

14. The computer case of claim 1, wherein the bottom panel is molded to form the structure on the inner surface thereof.
